(19) United States
(12) Patent Application Publication
(10) Pub. No.: US 2026/0351968 A1
(43) Pub. Date: Nov. 5, 2026

(54) SYSTEM AND METHOD FOR GRID CONGESTION MANAGEMENT USING INTEGRATED DIGITAL GRID ENHANCING TECHNOLOGIES

(71) Applicant: GridAstra, Inc., Frisco, TX (US)

(72) Inventors: Saugata Swapan BISWAS, Plano, TX (US); Tushar ., Bothell, WA (US); Sridevi BAYYAPUNEEDI, Dublin, CA (US); Shakteeswara Srinivas MUSUNURI, Bothell, WA (US)

(21) Appl. No.: 19/709,639

(22) Filed: Jun. 16, 2026

Related U.S. Application Data
(63) Continuation of application No. PCT/US2024/060409, filed on Dec. 16, 2024.
(60) Provisional application No. 63/611,174, filed on Dec. 17, 2023.

(51) Int. Cl. H02J 3/0012; G05B 13/04; H02J 13/12; H02J 103/35

(52) U.S. Cl. CPC H02J 3/0012; G05B 13/048; H02J 13/12; H02J 2103/35

(57) ABSTRACT

Disclosed herein are various systems and methods for predicting the location, magnitude, and time of congestion in an electrical grid due to overloading of branches such as lines, and thereafter mitigating such congestion across temporal and spatial dimensions. Various embodiments involve receiving multiple models and data for facilitating the generation of a digital replica of the electrical grid.

### CROSS-REFERENCE TO RELATED APPLICATIONS

This application is a continuation of International Application Number PCT/US2024/060409, filed on Dec. 16, 2024, which claims the benefit of U.S. Provisional Application No. 63/611,174, filed Dec. 17, 2023, each of which is incorporated by reference herein in its entirety.

### FIELD OF THE INVENTION

This disclosure relates to the monitoring, analysis and control of congestion in Electrical Power Grids (that may be caused due to the thermal overloading of the lines), and more particularly, to a system and method for the expansion of current carrying capacity of the Grid and effective re-routing of power through less congested or lightly loaded lines, in a reliable, resilient, and efficient manner.

### BACKGROUND

Electrical Power Systems are designed to generate, transmit, and distribute electrical energy to the loads in such a way that while maintaining the balance between generation, load demand, and losses, the voltages and flows throughout the Grid should must also remain within their respective reliability limits. Grid Congestion is caused when the power transmission through one or more lines or transformers in the Grid increase to such an extent that their reliability limits tend to be violated.

With the addition of newer Renewable Energy generation resources, Grid Congestion is at an all-time high in many regions worldwide, including North America, Europe, Asia Pacific, etc. Unlike the conventional generation resources, Renewables need to be located in those points of the Grid where the weather conditions are favorable for generating electricity and cannot just be located where there enough Grid capacity to carry excess power being generated. Due to this, when Renewables are connected to the Grid (at the point of interconnection), and start generating electricity, one or more transmission lines in the Grid can get overloaded beyond the rated reliability limits, thereby leading to Grid Congestion. The exacerbation of Grid Congestion has resulted in a pronounced deceleration of the integration of newer Renewable Energy generation assets into the Grid, thereby slowing down the transition to a greener Electricity Grid. A vast majority of Renewable developers are stuck in the ‘Interconnection-Queue’ for several years and are unable to get connected to the Grid due to foreseen impact of congestion.

Additionally, due to the rapid growth in Data Centers to power the advanced AI-enabled systems and due to the acceleration in the electrification of transportation such as adoption of electric vehicles, there is a significant growth in the power demand from the Grid, which is contributing to even more congestion in the Grid.

A category of existing solutions for mitigating Grid Congestion during medium to long-term planning of the Grid (e.g.—for the next 5 to 20 years) may include construction of new transmission lines or reconducting the existing ones in an attempt to increase the overall capacity of the Grid. However, such a solution is not only very costly but is also highly time-consuming due to environmental limitations, long permitting processes, shortage of skilled labor, to name a few. Given the unprecedented growth in transmission lines needed for Grid Capacity expansion, the afore-mentioned factors may create significant challenges for such an approach of alleviating congestion in the near future.

The conventional way of managing Grid Congestion during Operations (including short-term planning such as Day-Ahead Planning, or realtime operations) may include controls such as Generation Redispatch. In some embodiments, such redispatch may include curtailment of the lower cost generation such as from the Renewables and compensation of such decrease in generation with the increase in higher cost generation elsewhere in the Grid. This is resulting in insufficient utilization of the available low cost and clean generation from the Renewables, in turn leading to very high Congestion Costs. Since such additional costs are paid by the ratepayers, it brings a significant additional financial burden to them.

Another category of existing solutions for reducing Grid Congestion for both Grid Planning and Operations may include different forms of conventional ‘Grid Enhancing Technologies’ (hereafter referred to as ‘GETs’. In one embodiment, GETs may include Dynamic Line Rating (DLR) to dynamically compute Line Ratings in an attempt to increase Line Capacity. In another embodiment, GETs may also include Advanced Power Flow Controllers (APFCs) that may be mounted in the terminal substations of the lines in order to re-route power flow to reduce congestion. Another embodiment may include a limited form of Grid Topology Optimization (GTO) for re-routing the flow of power away from the congested or overloaded lines.

An inherent limitation associated with hardware-based GETs, specifically DLRs and APFCs, is their considerable deployment cost, rendering them non-scalable for system-wide implementation across the power grid. The hardware-based DLRs are susceptible to hardware failures, communication breakdowns, and are exposed to potential cyber threats. Moreover, the lack of centralized integration and coordination among GTO and the hardware-based GETs, including DLR and APFC, impedes their collective efficacy in mitigating Grid Congestion. Notably, there exists an absence of an automated decision support mechanism capable digitally modeling and co-optimizing the diverse GETs to facilitate the desired alleviation of Grid Congestion.

### SUMMARY OF THE INVENTION

Embodiments disclosed herein pertain to a novel system and method for managing Grid Congestion for both Grid Planning and Operations utilizing ‘Integrated Digital Grid Enhancing Technologies’ (hereinafter referred to as ‘ID-GETs’). The ID-GETs employ a ‘software-based’ paradigm, departing from conventional ‘hardware-based’ GETs approaches, thereby enabling a highly scalable approach for addressing congestion challenges within the Power Grid.

One facet of the ID-GETs system contemplates the establishment of a System-level Digital Replica of the Grid, encompassing a plurality of attributes, including but not limited to Power Systems models and data, Geospatial models and data, Individual Asset characteristic models and data, and Weather models and data. This comprehensive representation of the Grid is imperative for authentic emulation of its physical behavior, thereby enhancing the accuracy of Grid Congestion predictions.

Another facet of the ID-GETs system involves the integration of diverse analytical methodologies, including but not limited to Power System algorithms, Mechanical Fluid Dynamics algorithms, Data Science algorithms, and Artificial Intelligence/Machine Learning algorithms. Such amalgamation of varied analytical tools facilitates the utilization of both deterministic and non-deterministic models encapsulated within the Digital Replica for a realistic prediction of Grid Congestion.

A core aspect of the ID-GETs system pertains to the integration and co-ordination of the Digital Replica of diverse Grid Congestion Controllers that may include sensor-free ‘Software’ Dynamic Line Rating Controller (S-DLRC), ‘local and remote’ (i.e., wide area) Power Flow Controllers (LR-PFC), and Grid Topology Controller (GTC). In response to the prediction of the location, time, and the severity of congestion, one or more of these controls may be engaged and coordinated in an automated manner to provide optimal congestion relief.

The configuration of ID-GETs has been formulated to cater to a diverse spectrum of congestion relief use cases of Grid Planning and Operations spanning multiple time horizons of analysis. An embodiment of ID-GETs may encompass the prediction and alleviation of congestion during medium to long-term Grid Planning (e.g.—5 years for Generation and Load Interconnection Planning to 20 years for Regional Transmission Expansion Planning), relying on a scenario-based representation derived from the Digital Replica of the Grid. Another embodiment of ID-GETs may involve the prediction and alleviation of congestion for Grid Operations (e.g.—Day-Ahead Planning, Real-time and Look-Ahead Operations), considering various timepoints characterized by forecasted conditions obtained through the utilization of the Digital Replica of the Grid.

In an aspect, disclosed herein is system for prediction and mitigation of grid congestion, the system comprising: a processor configured to interface with a system-level digital replica of an electrical power grid (a “grid”), wherein creation of the system-level digital replica of the grid is based at least on a plurality of inputs comprising different representative models and data for emulation and prediction of a behavior of the grid; and a non-transitory computer-readable storage medium configured to interface with the processor, the medium comprising instructions configured to prompt the processor to: perform a predictive analysis of the grid based at least on a single timepoint or a plurality of timepoints for a basecase and one or more contingency cases related to (i) a plurality of grid planning scenarios, wherein the grid planning scenarios comprise planning periods of medium time periods or long time periods and (ii) a plurality of operations scenarios, wherein the operations scenarios comprise time periods of short-term planning, real-time operations, or look-ahead forecasts, wherein the predictive analysis is used to evaluate corresponding bus voltages and branch flows, wherein the branch flows comprise line flows or transformer flows, thereby identifying a plurality of congestion control candidates based at least on a congestion or an overload percentage in a plurality of branches; perform a predictive control analysis for congestion mitigation in at least one branch for the single timepoint or the plurality of timepoints for the basecase and the one or more contingency cases related to the plurality of grid planning scenarios and the plurality of operations scenarios based at least on a coordination of assets in the grid, wherein the assets comprise sensor-free software-based evaluation of dynamic line ratings, power flow controllers based line impedance change, or grid topology control based circuit breaker status change; perform a self-validation of a system impact of at least one congestion control candidate to determine a statistical probability of an undesirable side-effect; display results of the predictive analysis, the predictive control analysis, or the self-validation for the single timepoint or the plurality of timepoints.

In some embodiments, the plurality of inputs for the creation of the digital replica comprises: a first input comprising data determined from a power system network model; a second input comprising data determined from a power system geospatial and vegetation model; a third input comprising data determined from a power system asset characteristics model; and a fourth input comprising data determined from a power system weather observation model.

In some embodiments, the system is further configured to generate and process dynamic data, wherein the dynamic data comprises: a first input comprising a power system network state data; a second input comprising a power system generation pattern or profile data; a third input comprising a power system load pattern or profile data; a fourth input comprising a power system outage schedule; and a fifth input comprising a weather pattern.

In some embodiments, the system is further configured to: predict the bus voltages and the branch flows across the grid for the single timepoint or the plurality of timepoints for the basecase or the plurality of contingency cases; predict a list of branches through which the congestion or the overload percentage exceeds a user-defined threshold for the single timepoint or the plurality of timepoints; and generate a shortlist of branches as congestion control candidates for congestion mitigation control for the basecase or the plurality of contingency cases.

In some embodiments, the system is further configured to: provide capacity expansion control for at least one branch of the shortlist of branches by dynamically changing associated ratings using a sensor-free software dynamic line rating controller (S-DLRC).

In some embodiments, the system is further configured to: identify optimal locations in the grid for an evaluation of dynamic line ratings.

In some embodiments, the system is further configured to: autotune at least one of a plurality of weather attributes thereby mitigating an impact of bad data or missing data associated with historical data or forecasted data.

In some embodiments, the system is further configured to: perform a computation of a set of normal ratings of a congested line or a selected line, wherein the computation comprises applying a heat balance equation across the congested line or the selected line, and wherein the heat balance equation uses data associated with weather attributes, geospatial attributes, or line flow.

In some embodiments, the system is further configured to: perform a computation of maximum line conductor temperature based on the weather attributes, the geospatial attributes, or the line flow.

In some embodiments, the system is further configured to: perform a computation of emergency ratings at different time periods based at least on the weather attributes, the geospatial attributes, the line flow, or the maximum line conductor temperature.

In some embodiments, the system is further configured to: perform a computation of effective line ratings using a most limiting equipment rating in a line facility, wherein the computation is used to automatically identify limiting components based at least on (i) an associated topological connectivity with a line or (ii) definitions provided by a user.

In some embodiments, the system is further configured to: provide re-routing of power flow from congested branches to branches that are less congested by dynamically changing a line impedance of a line or a plurality of lines with power flow controllers, wherein the re-routing is performed by a wide-area based local and remote power flow controller (LR-PFC).

In some embodiments, the system is further configured to: perform a computation of sensitivities of the congested branches, wherein the sensitivities are associated with lines (i) having power flow controllers or (ii) to be configured with new power flow controllers or additional power flow controllers.

In some embodiments, the system is further configured to: create an optimal combination of the lines (i) having the power flow controllers or (ii) to be configured with the new power flow controllers or the additional power flow controllers; provide settings related to an impedance change for obtaining a power flow change on the congested branches; and perform a prediction of an impact of the power flow change on all branches in the grid caused by dynamically changing the line impedance using at least one power flow controller.

In some embodiments, the system is further configured to: provide re-routing of the power flow from each congested branch to branches that are less congested by dynamically changing a circuit breaker status of one line and bus or a plurality of lines and buses, wherein the re-routing is performed using a grid topology controller (GTC).

In some embodiments, the system is further configured to: perform a computation of sensitivities of the congested branches, wherein the computation comprises using all lines and buses in the grid.

In some embodiments, the system is further configured to: determine an optimal combination of switching the lines and buses based at least on a flow change requirement on the congested branches; automatically associate circuit breakers with the lines and buses for switching; and perform a prediction of an impact of the power flow change on all branches in the grid caused by a status change of at least one circuit breaker.

In some embodiments, the system is further configured to: provide an optimal coordination of all system controls, wherein the system controls comprise a software dynamic line rating controller (S-DLRC), a wide-area based local and remote power flow controller (LR-PFC), and a grid topology controller (GTC), and wherein the optimal coordination mitigates the congestion or the overload percentage in the branches for the one timepoint or the plurality of timepoints of the basecase and the plurality of contingency cases.

In some embodiments, the system is further configured to: perform a grid feasibility test with a short list of the system controls to determine a stability of a post-control grid state; perform a grid reliability test with the short list of the system controls to determine a loss of critical assets, wherein the critical assets comprise generators or loads, and wherein the loss is caused by an impact of at least one system control in the post-control grid state; perform a grid congestion test with the short list of the system controls to determine the congestion or the overload percentage in all branches in the post-control grid state, wherein, if any test fails, the optimal combination of system controls is changed automatically to alternative controls until (i) the congestion or the overload percentage of all branches in the grid is below a user-defined threshold or (ii) all possible combinations of system controls are considered.

In some embodiments, the system is further configured to: display results of the basecase and the contingency cases for the single timepoint or the plurality of timepoints determined from the predictive analysis; and display results of the basecase and the contingency cases for the single timepoint or the plurality of timepoints determined from the predictive control analysis.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the present disclosure. Accordingly, the drawings and description are to be regarded as illustrative in nature and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the present disclosure contained in the specification, the specification is intended to supersede and/or take precedence over any such contradictory material.

### BRIEF DESCRIPTION OF THE DRAWINGS

Embodiments of the disclosure that are non-limiting and non-exhaustive are described, including various embodiments of the disclosure with reference to the figures included in the Appendix, included herein and made a part hereof.

FIG. 1 illustrates an example schematic diagram of an Electrical Power Grid with monitoring, analysis, and control of congestion in accordance with embodiments of the technology disclosed herein.

FIG. 2A illustrates a flow chart of the method for monitoring, analysis, and control of congestion consistent with embodiments of the present disclosure.

FIG. 2B illustrates a flow chart of the method for receiving a plurality of models representing diverse attributes of the Grid that may be used in connection with the method illustrated in FIG. 2A consistent with embodiments of the present disclosure.

FIG. 2C illustrates a flow chart of the method for receiving a plurality of dynamic information corresponding to different attributes of the Grid that may be used in connection with the method illustrated in FIG. 2A consistent with embodiments of the present disclosure.

FIG. 2D illustrates a flow chart of the method for controlling the capacity expansion of one or more congested lines by changing their Ratings dynamically using sensor-free Software Dynamic Line Rating Controller (S-DLRC) that may be used in connection with the method illustrated in FIG. 2A consistent with embodiments of the present disclosure.

FIG. 2E illustrates a flow chart of the method for controlling the power flow through one or more lines by changing the line impedance dynamically using the locally and remotely installed Power Flow Controllers (LR-PFCs) that may be used in connection with the method illustrated in FIG. 2A consistent with embodiments of the present disclosure.

FIG. 2F illustrates a flow chart of the method for controlling the power flow through one or more lines by Grid Topology Control (GTC) by switching the Circuit Breakers in substations that may be used in connection with the method illustrated in FIG. 2A consistent with embodiments of the present disclosure.

FIG. 3 illustrates a flow chart of the method for monitoring, analysis, and control of congestion across multiple timepoints consistent with embodiments of the present disclosure.

### DETAILED DESCRIPTION

Throughout the present description of the invention, it is to be acknowledged that a term appearing in the singular encompasses its plural counterpart, and conversely, a term appearing in the plural encompasses its singular counterpart, unless implicitly or explicitly understood or stated otherwise. Moreover, it is to be comprehended that, for any given component or embodiment elucidated herein, any of the potential candidates or alternatives enumerated for that component may generally be employed individually or in combination with one another, unless implicitly or explicitly understood or stated otherwise. Furthermore, the figures depicted herein have some elements possibly represented for the sake of clarity in illustrating the invention. Additionally, reference numerals may be reiterated across various figures to denote corresponding or analogous elements. It is also appreciated that any enumeration of such candidates or alternatives is purely illustrative and not limiting unless implicitly or explicitly understood or stated otherwise.

Moreover, unless explicitly stated otherwise, numerical expressions representing quantities of constituents, reaction conditions, and similar aspects disclosed in the specification and claims are to be construed as being modified by the term “about.” Consequently, unless indicated otherwise, the numerical values presented in the specification and appended claims are approximate and subject to variation depending on the desired properties sought to be achieved by the disclosed subject matter. Notably, and without intending to restrict the application of the doctrine of equivalents to the bounds of the claims, each numerical parameter should at least be interpreted in consideration of the number of reported significant digits and through the application of conventional rounding methods. Despite the approximative nature of the numerical ranges and parameters delineating the broad scope of the disclosed subject matter, the numerical values provided in the specific examples are reported with maximal precision. It is acknowledged, however, that any numerical values inherently encompass certain errors arising from the standard deviation inherent in their respective testing observations.

The embodiments disclosed herein are most effectively comprehended through reference to the accompanying drawings. It is evident that the components of the disclosed embodiments, presented in a general manner and illustrated in the figures herein, can be configured and designed in a multitude of diverse arrangements. Consequently, the ensuing detailed description of the embodiments of the systems and methods disclosed herein is not intended to restrict the scope of the claimed disclosure but rather serves as an illustrative representation of potential embodiments of the disclosure. Furthermore, the sequence of steps in a method is not necessarily bound by a specific order or sequential execution, nor are the steps limited to a singular occurrence unless explicitly specified otherwise.

In certain instances, features, structures, or operations widely recognized within the field are not explicitly depicted or detailed. Additionally, the features, structures, or operations described herein can be integrated in any suitable configuration within one or more embodiments. For instance, within this specification, any mention of “one embodiment,” “an embodiment,” or “the embodiment” signifies that a specific feature, structure, or characteristic delineated in relation to that embodiment is encompassed in at least one embodiment. Consequently, the quoted phrases or their variations, as articulated throughout this specification, do not uniformly pertain to a singular embodiment.

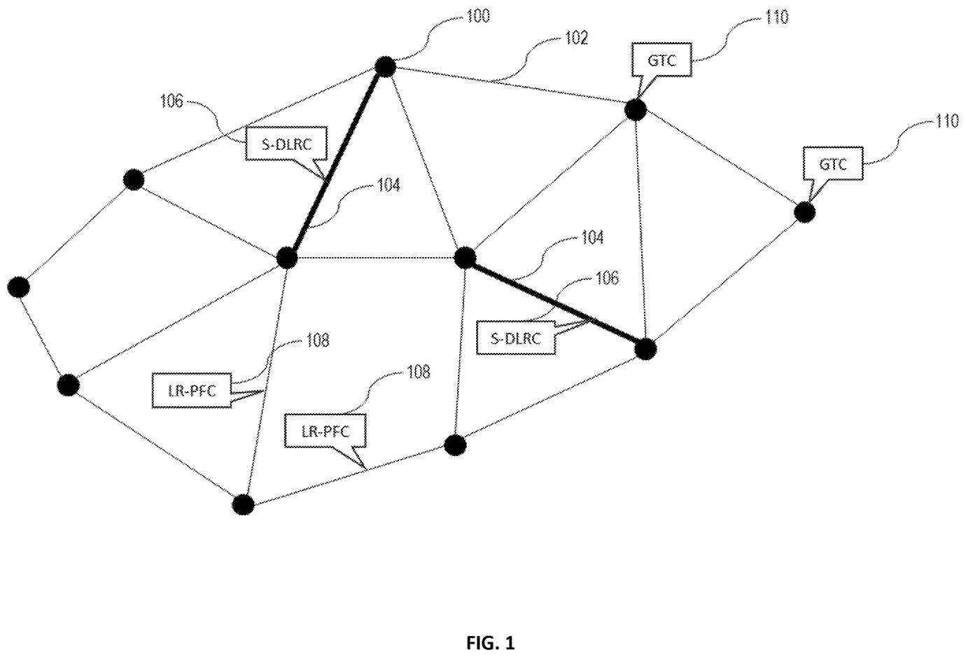

FIG. 1 illustrates an example schematic diagram of an Electrical Power Grid with monitoring, analysis, and control of congestion in accordance with embodiments of the technology disclosed herein. An Electrical Power System is designed to generate, transmit, and distribute electrical energy to the loads. Such a system comprises of a plurality of substations 100 connected to each other through a meshed network of transmission, sub-transmission, and distribution lines 102. A substation may include one or more equipment such as-buses, circuit breakers, switches, electric generators (such as coal, gas, hydro, nuclear, wind, solar, storage, static VAR compensators, to name a few), loads (supplying power to Industrial facilities, commercial facilities, residential complexes, data centers, and the like), power transformers, capacitor/reactor banks, different types of controls (such as Power Flow Controllers) and protective devices, and the like.

In such a system, at any given point of time, the amount of generation must be equal to the sum of load demand and the losses. Yet, while maintaining this balance, it is of paramount importance to maintain the bus voltages and power flow through the branches including lines and transformers within their respective reliability limits determined primarily by thermal and stability limits. FIG. 1 shows 2 distinct lines denoted as 104 through which the power flow exceeds their respective thermal limits, thereby causing congestion.

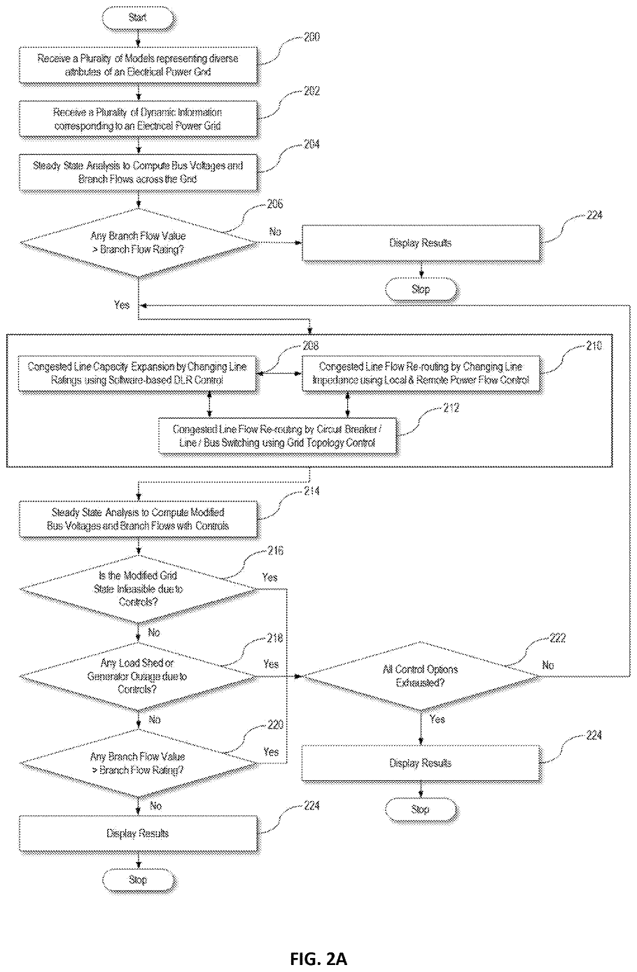

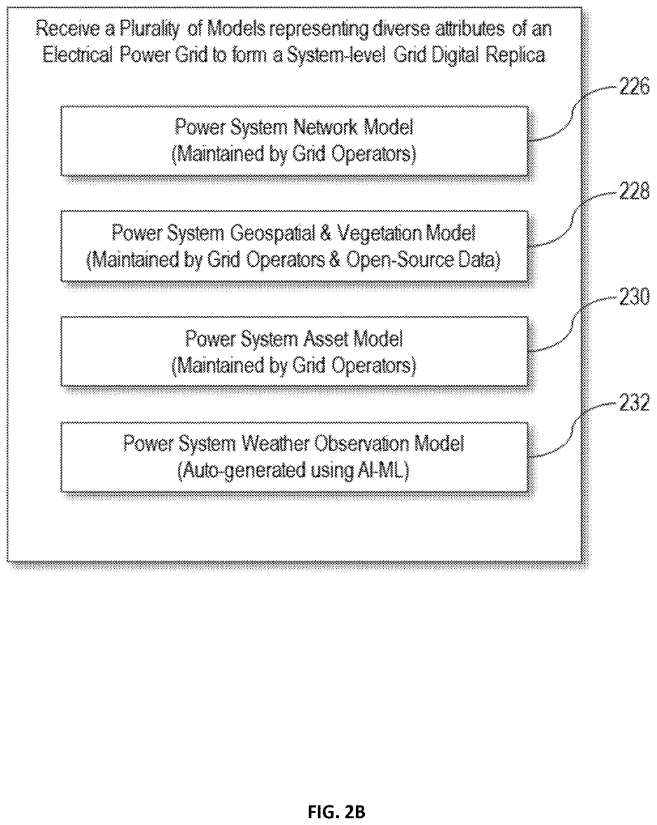

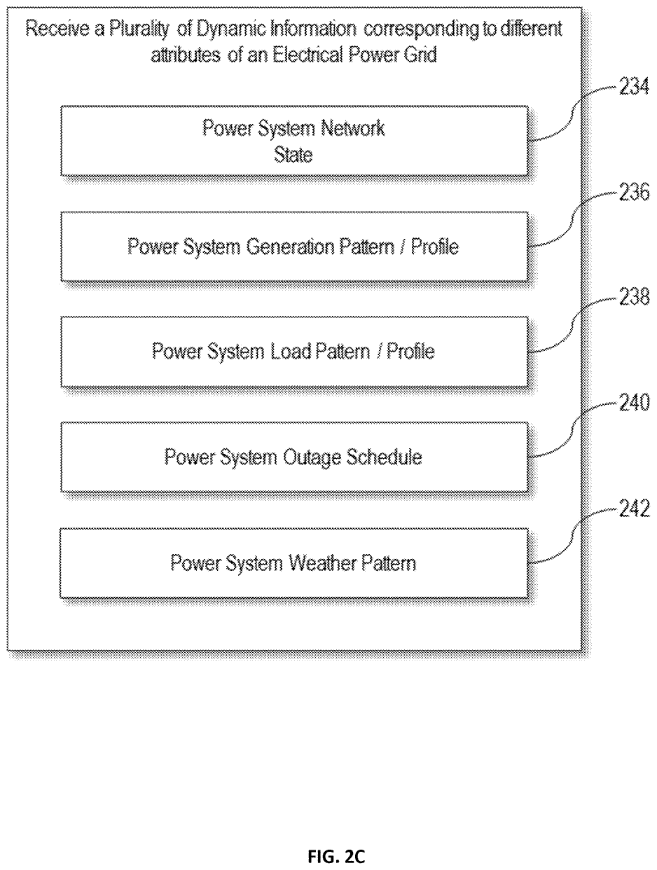

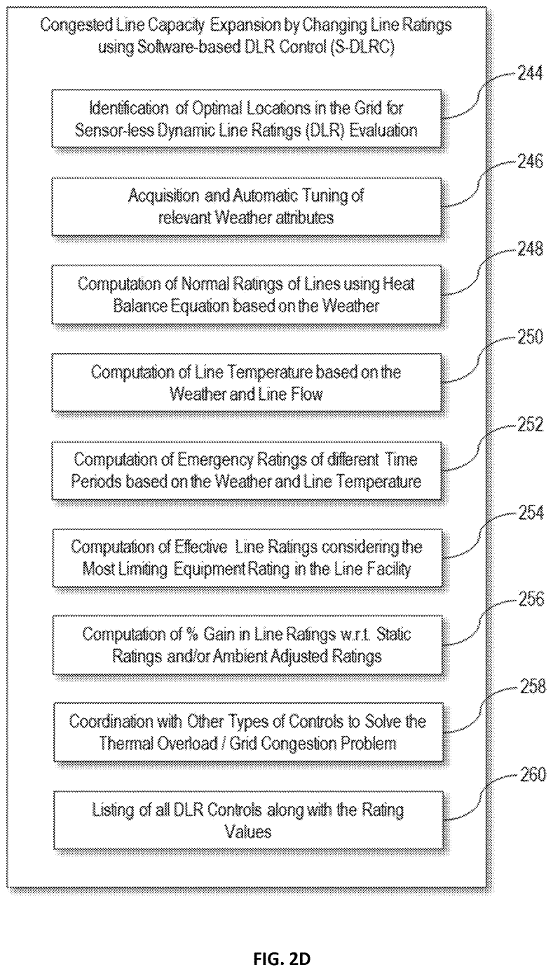

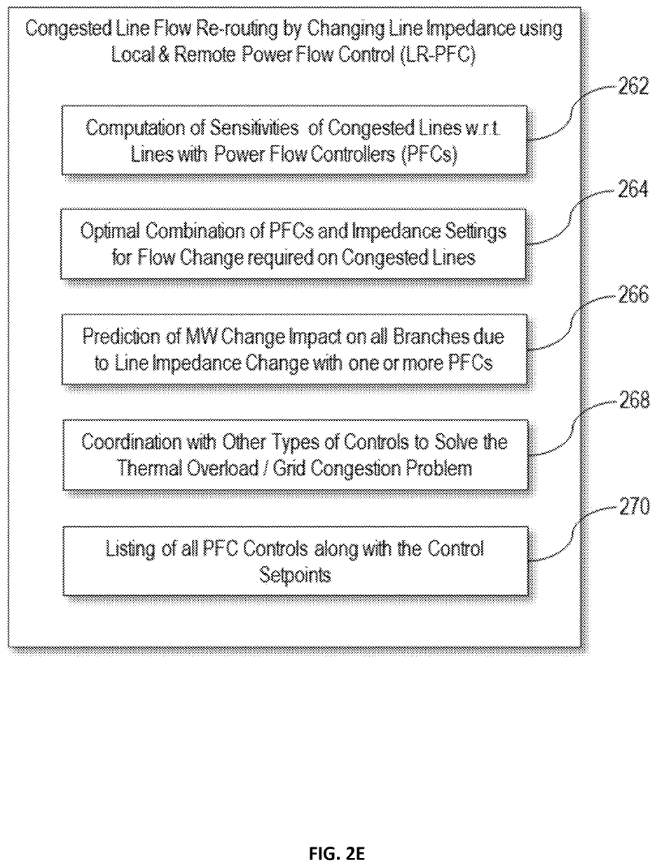

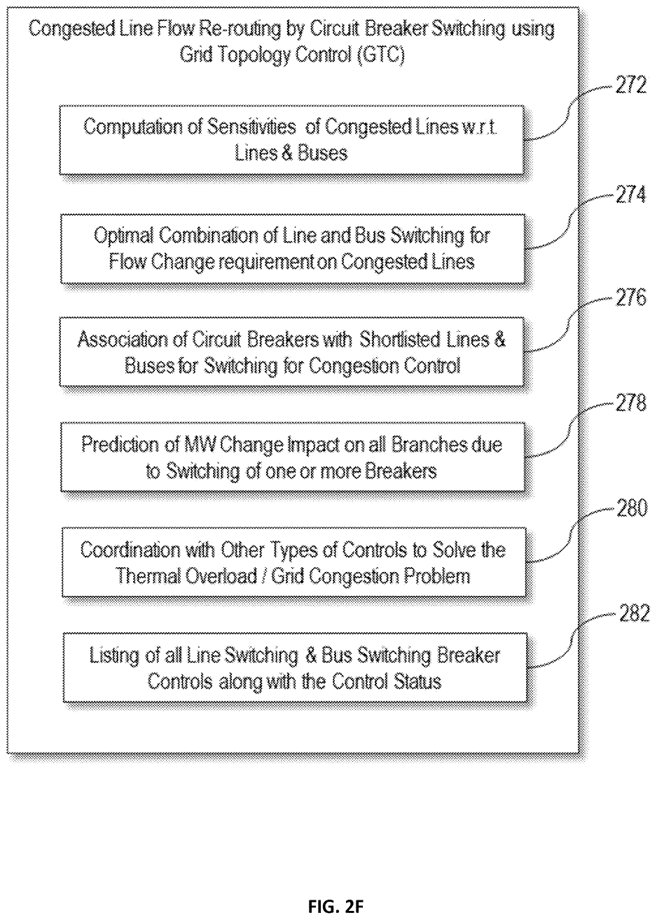

FIG. 2A illustrates a flow chart of the method for monitoring, analysis, and control of thermal overloads and Grid Congestion consistent with embodiments of the present disclosure. Embodiments disclosed herewith relate to an innovative system and methodology for mitigating Grid Congestion employing ‘Integrated Digital Grid Enhancing Technologies’ (hereinafter denoted as ‘ID-GETs’). The ID-GETs system utilizes a ‘software-based’ framework, and facilitates a highly scalable methodology for confronting congestion issues within the Power Grid.

At 200, a plurality of models representing diverse attributes of an Electrical Power Grid is received. FIG. 2B illustrates a flow chart of a method for receiving a plurality of input models that may be used in connection with the method illustrated in FIG. 2A consistent with embodiments of the present disclosure. In various embodiments, the plurality of models received at 200 may include one or more of: Power System Network Model 226, Power System Geospatial Model 228, Power System Asset Model 230, and Power System Weather Observation Model 232 to form a Digital Replica of the Grid. Various embodiments may include more or fewer parameters than those listed here. Such a comprehensive system-level Digital Replica of the Grid is indispensable for a realistic emulation of its physical behavior, thereby augmenting the precision of Grid Congestion prediction.

In one embodiment, the Power System Model 226 may include the representation of the physical topological connectivity of a variety of devices in the Grid such as buses, circuit breakers, switches, lines, electric generators, loads, power transformers, capacitor/reactor banks, different types of controls (such as Power Flow Controllers), and the like. In another embodiment, the Power System Model 226 may also include the mathematical representation of the electrical characteristics of the various electrical devices connected in the Grid to adequately model the physical behavior of a plurality of electrical parameters such as voltage, current, real power, reactive power, to name a few. The Power System Model 226 can be represented in diverse forms that may include a Node-Breaker model that is typically used for operational analysis, or Bus-Branch model that is typically use for long-term planning.

The Power System Geospatial Model 228 may include the required 3-dimensional location of the substations and the lines connecting them in the Grid, along with the geographical terrain and vegetation cover information corresponding to the relevant Power System asset locations, and the like. In one embodiment of the Power System Geospatial Model 228, substations may be generally denoted by a single value of latitude, longitude, and altitude. In another embodiment of the Power System Geospatial Model 228, lines may be generally denoted by a plurality of latitude, longitude, and altitude sets, considering its topography that may include but not limited to the associated span length, tower altitude, and inter-span azimuth. In another embodiment of the Power System Geospatial Model 228, various relevant attributes of the terrain and vegetation cover in close proximity with the Power System assets that can have reasonable impact on the heating and cooling characteristics of such assets may be included.

The Power System Asset Model 230 may include the representation of non-electrical properties of different assets in the Grid. One embodiment of such an asset as an example may include the fluid dynamics modeling of lines connecting the substations to accurately assess their thermal behavior and current-carrying ability under different conditions. The Asset model of lines may include a plurality of attributes but is not limited to: material of the conductor, area of cross-section, total heat capacity, mass per unit length, AC resistance variation with temperature, solar absorptivity, emissivity, and the like.

The Power System Weather Observation Model 232 may include the representation of the optimal locations in the Grid where different attributes of weather data can be observed. Such weather attributes may include but are not limited to: ambient temperature, wind speed, wind direction, humidity, atmospheric pressure, cloud cover, and the like. The locations in the Grid are chosen optimally based on an unsupervised learning-based machine-learning technique such that with minimal number of weather observation locations, adequate weather data coverage for all the substations and all spans of lines in the Grid i.e., completed weather impact observability of the Grid can be achieved. Weather observation locations may also include the locations of physical weather stations that are in close proximity to the substations and/or lines.

At 202, a plurality of dynamic information representing diverse attributes of an Electrical Power Grid is received. FIG. 2C illustrates a flow chart of a method for receiving a plurality of input dynamic data that may be used in connection with the method illustrated in FIG. 2A consistent with embodiments of the present disclosure. In various embodiments, the plurality of dynamic information received at 202 may include one or more of: Power System Network State 234, Power System Generation Pattern/Profile 236, Power System Load Pattern/Profile 238, and Power System Outage Schedule 240 to complement the Digital Replica of the Grid. Various embodiments may include more or fewer parameters than those listed here.

Power System Network State 234 may represent the electrical attributes of the Grid such as: voltages, angles, real power injection, and reactive power injection at all buses in the Grid, power flow through all the branches including lines and transformers, and the topological status of all devices based on circuit breaker or switch status. In one embodiment, such Power System Network State 234 can be obtained from a Realtime State Estimator that observes and estimates all the states of a Grid in real time. In another embodiment, the Power System Network State 234 can be created manually based on changes in the Network to represent a hypothetical state of the Grid that may be needed for analysis of extreme conditions in the Grid for medium to long-term planning. Such hypothetical states may correspond to but are not limited to peak load situations, low load situations, high wind situations, to name a few.

Power System Generation Pattern/Profile 236 may represent the forecast of the temporal variation of power output of a plurality of generators connected to the Grid. Different generators of different types may be committed at different times for generating electricity of varying magnitudes to meet the load demand and system losses. In one embodiment, such generation pattern may be forecasted based on a plurality of factors including but not limited to the historical generation patterns, historical generation prices, historical weather patterns, forecasted weather patterns, and the like. When ‘ID-GETs’ is configured for the prediction and alleviation of congestion for operational planning of the Grid, the use of such time-varying generation pattern characterized by the forecasted conditions may significantly enhance the accuracy of the prediction of Grid Congestion.

Power System Load Pattern/Profile 238 may represent the forecast of the temporal variation of power consumption of a plurality of loads connected to the Grid. In one embodiment, such load pattern may be forecasted based on a plurality of factors including but not limited to the historical load patterns, historical weather patterns, forecasted weather patterns, and the like. When ‘ID-GETs’ is configured for the prediction and alleviation of congestion for operational planning of the Grid, the use of such time-varying load pattern characterized by the forecasted conditions may significantly enhance the accuracy of the prediction of Grid Congestion.

Power System Outage Schedule 240 may represent the forecast of the temporal variation of Grid Topology status. Variation of Grid Topology may be in the form of change in Circuit Breaker or Switch statuses, or may also be in the form of change of connection status of the different devices connected in the Grid, or both. In one embodiment, the topological changes in the Grid may be due to the planned outages initiated because of a planned maintenance schedule, which may encompass one or more equipment going out of service or coming back into service. In another embodiment, topological changes may also be forced upon due to extreme weather events. When ‘ID-GETs’ is configured for the prediction and alleviation of congestion for operational planning of the Grid, the use of such time-varying outage schedule pattern characterized by the forecasted conditions may significantly enhance the accuracy of the prediction of Grid Congestion.

Power System Weather Pattern 242 may represent the forecast of the temporal variation of a plurality of weather attributes such as: ambient temperature, wind speed, wind direction, humidity, atmospheric pressure, cloud cover, and the like, observed at the optimal locations in the Grid as identified in 232. Such weather attributes can significantly affect the operations of the grid by impacting generation, load power consumption, and current-carrying capacity of the lines, to name a few. When ‘ID-GETs’ is configured for the prediction and alleviation of congestion for operational planning of the Grid, the use of such time-varying outage schedule pattern characterized by the forecasted conditions may significantly enhance the accuracy of the prediction of Grid Congestion.

At 204, Steady State Analysis is performed based on the ingested models and dynamic information pertaining to the Digital Replica of the Grid in 200 and 202 respectively. In one embodiment, a Steady State Analysis may pertain to the computation and prediction of basecase values of a plurality of electrical attributes including but not limited to: voltage phasors at each bus or node of the Grid, real and reactive power flows through each branch such as lines and transformers of the Grid, and real and reactive power generation or consumption by any equipment connected to the Grid. In another embodiment, a Steady State Analysis may also include the computation and prediction of such electrical attributes of the Grid under a post-contingent scenario involving the outage of one or more devices in the Grid.

At 206, the computed or predicted values of flow through the branches such as lines and transformers in 204 are compared with their corresponding static or ambient adjusted rating values for evaluating congestion or overloading percentage. If such congestion or loading percentage value of any branch exceeds the user-defined threshold, that branch becomes a candidate for congestion relief through ID-GETs controls. All such congested branches are archived internally for controls processing. On the contrary, if the congestion percentage is lesser than the user-defined threshold for all branches with voltage values at all buses within rated limits, then no further processing may be required and just the predictive results are displayed on the User Interface.

At 208, the congested branches are evaluated based on a plurality of attributes that play a role in the computation of their dynamic ratings based on a sensor-free scalable approach. FIG. 2D illustrates a flow chart of a method for such computation of Software Dynamic Line Rating Controller (S-DLRC) that may be used in connection with the method illustrated in FIG. 2A consistent with embodiments of the present disclosure. In various embodiments, the plurality of inputs corresponding to the Grid Digital Replica models in FIG. 2B and the dynamic information received in FIG. 2C may be used for dynamic rating evaluation of lines.

At 244, optimal locations in the Grid are identified to provide complete visibility of the impact of a plurality of factors that may determine the heating and cooling of line conductor. Factors considered for optimal location identification may include but are not limited to: 3-dimensional attributes of critical points or spans along the entire stretch of a line, weather conditions at the weather observation locations, availability of weather stations, terrain type, vegetation cover, solar heating patterns, conductor type or characteristics, and topological line connectivity, to name a few. Once identified, such locations in the Grid are used for evaluating dynamic line ratings.

At 246, a plurality of weather attributes obtained from the weather observation locations identified in 232 are processed. Such weather attributes may include but are not limited to: ambient temperature, wind speed, wind direction, humidity, atmospheric pressure, cloud cover, and the like. To prevent the impact of bad or missing data in the weather attributes, they are analyzed temporally w.r.t. their historical and forecasted counterparts as well as spatially with adequate overall redundancies. In this process of automated tuning, the outliers may be replaced with their most likely estimates.

At 248, Normal Dynamic Rating of a line that corresponds to its continuous current carrying capacity may be computed using fluid dynamics model driven heat balance equation (as per IEEE or CIGRE standard). Such heat balance equation tends to balance the heat gain of the conductor due to solar heating and current flowing through it with heat losses in the form of convection and radiation. In one embodiment, the maximum permissible heating of the line conductor used in this fluid dynamics of the line may be specified by the user depending on the material of the conductor and its heating characteristics. In another embodiment, the maximum permissible heating of the conductor may also consider additional factors such as line sagging that may be computed additionally. The Dynamic Normal Rating of a line shall be evaluated based on the point of maximum heating across its entire stretch.

At 250, line conductor temperature may be computed across the stretch of the line using the time derivative of the heat balance equation. The terms governing heat transfer and conductor resistance are contingent upon the conductor temperature, while solar heating input to the conductor remains constant at a given time. The heat balance equation necessitates solving for the conductor temperature in terms of the weather-related variables as well as the flow of current through the conductor through a numerical iteration process. A provisional conductor temperature is assumed initially, from which the conductor resistance is computed for the given temperature. Concurrently, considering the observed weather conditions, the convection and radiation heat loss terms are evaluated. The conductor current is deduced through the heat balance equation. This calculated current is juxtaposed with the provisional conductor current. Subsequently, the provisional conductor temperature is adjusted iteratively, until the calculated current aligns with the provisional current within a tolerance specified by the user to provide the final estimation of conductor temperature.

At 252, Dynamic Emergency Ratings of a line for different timeframes may be computed based on the point of maximum heating across its entire stretch and the maximum permissible short-term conductor heating permissible based on the conductor type and heating characteristics. In one embodiment, such Emergency Line Ratings can be obtained by iterative repetition of calculations for conductor temperature across a spectrum of current values. Subsequently, the optimal current value may be identified by the magnitude that induces the maximum conductor temperature within the designated timeframe.

At 254, the Dynamic Normal and Emergency Ratings computed for a line may be adjusted or derated based on the ratings of the other devices connected with the line of interest. In one embodiment of the current disclosure, such limiting components may be automatically identified based on their topological connectivity with the line. In another embodiment, the limiting components associated with a line may be defined by the user prior to the ratings evaluation. Limiting components may include but are not limited to: substation circuit breakers or switches, transformers, jumpers, line traps, and wave traps, to name a few. The ratings of each of the limiting component candidates may be evaluated based on the weather conditions observed at the substation to which they belong to. The minimum of the most-restrictive rating of the limiting component associated with line and the line's Dynamic Rating is finally attributed as the Effective Dynamic Line Rating.

At 256, the percentage gain of the Normal and different types of Dynamic Line Ratings are evaluated w.r.t. their static or ambient adjusted counterparts. While a positive gain percentage may indicate increase in the line's current carrying capacity, which may lead to congestion relief, a negative gain percentage may indicate the reverse. Only lines with positive gain percentage are considered for congestion relief using Dynamic Line Rating methodology.

At 258, Software Dynamic Line Rating Controller (S-DLRC) may be coordinated with other control types in ID-GETs such as Local & Remote Power Flow Controller (LR-PFC) and Grid Topology Controller (GTC) for one or more branches whose percentage loading or congestion exceeds the user-defined threshold in an attempt to mitigate their congestion issue.

At 260, all the Dynamic Line Rating Controls computed for branch congestion or overload mitigation are listed on the user-interface as one form of automated decision support provided by ID-GETs.

At 210, the congested or overloaded branches are evaluated based on the possibility of re-routing power from them to lesser congested branches in the Grid using Power Flow Controllers effectively. In one embodiment, the most optimal locations for installing Power Flow Controller(s) in the Grid to mitigate overloading or congestion issues may be determined, such that with the minimum number of such device installations, the maximum benefit in terms of congestion relief can be achieved. This can be especially of high significance during the medium to long-term Planning of the Grid. In another embodiment, the control settings of such Power Flow Controller(s) associated with one or a plurality of lines may be altered by ID-GETs' Local & Remote Power Flow Control (LR-PFC) algorithm to change their effective impedance to change the power flow through such lines, locally or remotely w.r.t. the point(s) of congestion. FIG. 2E illustrates a flow chart of a method for such computation of Impedance Settings of Power Flow Controllers associated with lines that may be used in connection with the method illustrated in FIG. 2A consistent with embodiments of the present disclosure. In various embodiments, the plurality of inputs corresponding to the Grid Digital Replica models in FIG. 2B may be used for the computation of Power Flow Controller settings necessary for changing the line power flow patterns.

At 262, the sensitivities of congested or overloaded lines are computed w.r.t. those lines in the Grid that are either possible candidates for installation of Power Flow Controllers or already have Power Flow Controllers installed on them (hereafter referred to as control candidate lines). Such sensitives may be computed based on a plurality of factors including but not limited to: line impedances, topological connectivity and state of the grid, to name a few.

At 264, optimal combination of one or a plurality of control candidate lines is created to meet the flow change needed through the congested lines for congestion mitigation based on the sign and magnitude of these sensitivities. For the flow change needed in each of these control candidate lines, their impedance parameters are varied as permissible by the Power Flow Controllers associated with them. During medium and long-term Planning of the Grid, including but not limited to Generation Interconnection Planning, Load Interconnection Planning, and Transmission Expansion Planning, such optimal combination shall be manifested in the form of providing automated suggestions for installing new Power Flow Controllers at new locations or relocating existing Power Flow Controllers to new location(s) along with their required control settings. On the contrary, during short-term Operations of the Grid, including Day-Ahead Planning, Realtime Operations, or Look-Ahead Operations Planning, such optimal combination shall be manifested in the form of providing the required control settings for the existing Power Flow Controllers in their existing locations in the Grid.

At 266, predictive analysis is performed with the modified impedance parameters of the optimally chosen control candidate lines based on their respective modified Power Flow Controller settings. Such predictive analysis may include but not be limited to the prediction of the updated flows through all the branches such as lines and transformers in the Grid along with the updated voltages at all the buses in the Grid.

At 268, Local & Remote Power Flow Controller (LR-PFC) may be coordinated with other control types in ID-GETs such as Software Dynamic Line Rating Controller (S-DLRC) and Grid Topology Controller (GTC) for one or more branches whose percentage congestion exceeds the user-defined threshold in an attempt to mitigate their congestion issue. If voltage of one or a plurality of buses in the Grid is not within the rated secure limits, the required voltage control may be performed using different types of controls that may include but not be limited to: capacitor/reactor switching, modification of voltage settings of generators, Static VAR Compensators, and the likes.

At 270, all the Impedance related Settings computed for branch congestion or overload mitigation by the Local & Remote Power Flow Controller (LR-PFC) are listed on the user-interface as one form of automated decision support provided by ID-GETs.

At 212, the congested or overloaded branches are evaluated based on the possibility of re-routing power from them to lesser congested branches in the Grid by changing the Grid Topology effectively. The topology may be altered by ID-GETs' Grid Topology Control (GTC) algorithm by changing the status of circuit breakers or switches or isolators or lines or buses or a combination of such devices in substations, locally or remotely w.r.t. the point(s) of congestion. In one embodiment, circuit breakers or switches may be associated with a line leading to either innage or outage of that line as a part of topology control. In another embodiment, the circuit breakers may be associated with one or a plurality of buses leading to bus split or bus merge. FIG. 2F illustrates a flow chart of a method for such computation of Switching Status Settings of Circuit Breakers associated with lines and/or buses that may be used in connection with the method illustrated in FIG. 2A consistent with embodiments of the present disclosure. In various embodiments, the plurality of inputs corresponding to the Grid Digital Replica models in FIG. 2B may be used for the computation of topology change controls necessary for changing the line power flow patterns.

At 272, the sensitivities of congested or overloaded lines are computed w.r.t. the relevant lines and buses in the Grid (hereafter referred to as control candidate lines and buses). Such sensitives may be computed based on a plurality of factors including but not limited to: line impedances, topological connectivity and state of the grid, to name a few.

At 274, optimal combination of status change of one or a plurality of control candidate lines and buses is created to meet the flow change needed through the congested lines for congestion mitigation. This may be based on a plurality of factors including but not limited to: the sign and magnitude of these sensitivities, the flow through the control candidate lines, and bus sensitivities, to name a few.

At 276, each control candidate line and bus shortlisted for congestion mitigation is automatically associated with their corresponding circuit breakers based on the node-breaker topological connectivity. For accomplishing the flow change needed in the congested lines, such circuit breakers corresponding to the control candidate lines and buses are either opened or closed in an attempt to re-route the power flow off the congested lines to the less congested ones having additional current carrying capacity.

At 278, predictive analysis is performed either with the modified circuit breaker statuses of the optimally chosen control candidate lines and buses, or directly with the modified switching status of lines and buses. Such predictive analysis may include but not be limited to the prediction of the updated flows through all the branches such as lines and transformers in the Grid along with the updated voltages at all the buses in the Grid.

At 280, Grid Topology Controller (GTC) may be coordinated with other control types in ID-GETs such as Software Dynamic Line Rating Controller (S-DLRC) and Local & Remote Power Flow Controller (LR-PFC) for one or more branches whose percentage congestion exceeds the user-defined threshold in an attempt to mitigate their congestion issue. If voltage of one or a plurality of buses in the Grid is not within the rated secure limits, the required voltage control may be performed using different types of controls that may include but not be limited to: capacitor/reactor switching, modification of voltage settings of generators, Static VAR Compensators, and the likes.

At 282, all the circuit breaker status changes, line status changes, and bus status changes computed for branch congestion mitigation by the Grid Topology Controller (GTC) are listed on the user-interface as one form of automated decision support provided by ID-GETs.

At 214, predictive analysis is performed with all the coordinated ID-GETs based controls shortlisted in 208, 210, and 212 and superimposed on the original state of the Grid in 204. In one embodiment, such predictive analysis may include but not be limited to the prediction of the updated flows through all the branches such as lines and transformers in the Grid along with the updated voltages at all the buses in the Grid.

At 216, Grid Feasibility Test is performed to ensure that grid stability issues are not caused due to the coordinated actions of the ID-GETs controls. Stability issues tested may include but not limited to the imbalance of real power demand and supply, voltage collapse, and the likes across the entire Grid or in individual Islands of the Grid if more than one island exists. If the Grid Feasibility Test is not passed, the control action(s) with the highest participation factor towards such stability issue(s) are identified and removed from the shortlisted list of controls, and the process of finding optimal control combinations for congestion relief is restarted from 208. Such an iterative process is continued unless the Grid Feasibility Test is passed successfully, or all legitimate control options are fully exhausted as shall be determined in 222.

At 218, Grid Reliability Test is performed to ensure that there are no undesired outages of key grid assets that may include but not limited to generators and loads, due to the coordinated actions of the ID-GETs controls. If the Grid Reliability Test is not passed, the control action(s) with the highest participation factor towards such reliability issue(s) are identified and removed from the shortlisted list of controls, and the process of finding optimal control combinations for congestion relief is restarted from 208. Such an iterative process is continued unless the Grid Feasibility Test is passed successfully, or all legitimate control options are fully exhausted as shall be determined in 222.

At 220, Grid Congestion Test is performed to ensure that there are no branches such as lines or transformers in the grid that have congestion or loading percentage above user-defined limits, due to the coordinated actions of the ID-GETs controls. If the Grid Congestion Test is not passed, the control action(s) with the highest participation factor towards such congestion issue(s) are identified and removed from the shortlisted list of controls, and the process of finding optimal control combinations for congestion relief is restarted from 208. Such an iterative process is continued unless the Grid Congestion Test is passed successfully, or all legitimate control options are fully exhausted as shall be determined in 222.

If the Grid Feasibility Test in 216, Grid Reliability Test in 218, and Grid Congestion Test in 220 are all passed successfully, the final list of detailed coordinated control actions of ID-GETs is displayed on the user interface along with the prediction of post-control state of the Grid at 224 as a form of automated decision support for the user for congestion mitigation.

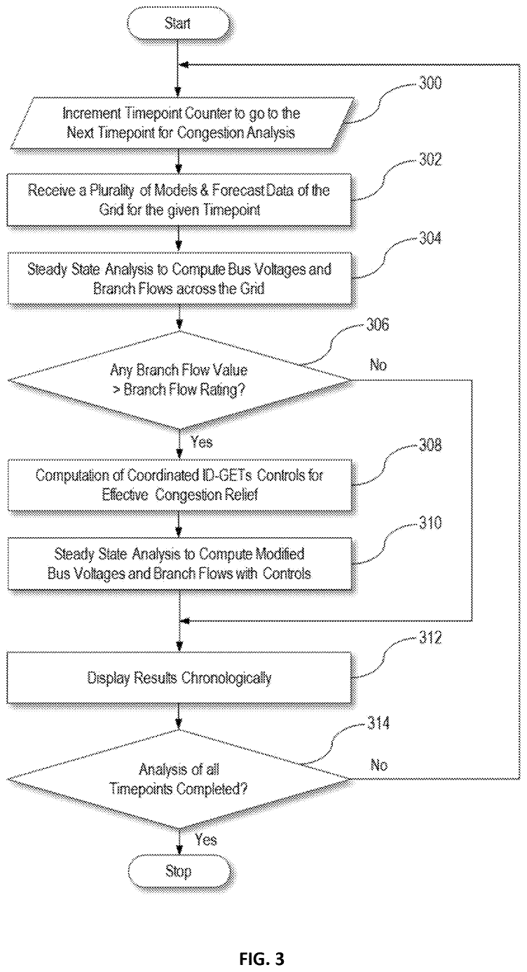

FIG. 3 illustrates a flow chart of the method for monitoring, analysis, and control of congestion across multiple timepoints consistent with embodiments of the present disclosure. Embodiments disclosed herewith relate to an innovative system and methodology for mitigating Grid Congestion using ID-GETs across a plurality of timepoints based on forecasted quantities pertaining to varying Grid conditions and weather. At 300, a counter representing the timepoint of analysis is used to navigate through the plurality of forecasted snapshots of the Grid. A plurality of models forming the Digital Replica of the Grid along with forecast data associated with the selected timepoint is received in 302. At 304, predictive analysis is performed to compute the flows through all the branches such as lines and transformers in the Grid along with the voltages at all the buses in the Grid for the analyzed timepoint. At 306, it is evaluated whether any of the branches such as lines or transformers in the Grid have percentage congestion or loading higher than the user-defined threshold. If no such branch exists, the predictive state of the Grid for that timepoint is visualized chronologically on the user-interface at 312. On the contrary, if there is one or a plurality of branches having percentage congestion higher than the user-defined threshold, all such branches are automatically selected as candidates for congestion mitigation based on ID-GETs controls in 308. Such ID-GETs controls may involve the coordination of a plurality of controls across: Sensor-free Software Dynamic Line Rating control for line capacity expansion, Power Flow Controllers based line impedance control for re-routing power flow from the congested lines to the lesser congested ones, and Grid Topology control involving switching of circuit breakers in substations that may correspond to lines or buses in an attempt to reconfigure the flow of power through the Grid. At 310, all the shortlisted group of control actions of ID-GETs are superimposed on the original state of the Grid and the future state with such controls is predicted for that timepoint as measure of self-validation feature of ID-GETs. At 312, the predictive state of the Grid based on the ID-GETs controls for that timepoint is visualized chronologically on the user-interface. At 314, it is checked to find if all the designated timepoints have been analyzed and the iterative loop of state predictions and controls are continued until the analyses of all the timepoints have been completed.

Several facets of the embodiments disclosed herein may be implemented as software modules or components. Within the context herein, a software module or component encompasses any form of computer instruction or executable code residing within a memory device, operable in conjunction with suitable hardware to execute the programmed instructions. A software module or component may consist of one or more physical or logical blocks of computer instructions, arranged as a routine, program, object, component, data structure, etc., capable of performing specific tasks or realizing particular abstract data types.

Within certain embodiments, a designated software module or component may encompass diverse instructions stored in varied locations within a memory device, collectively effectuating the specified functionality of the module. Indeed, a module or component may consist of a singular instruction or a multitude of instructions, distributed across different code segments, various programs, and multiple memory devices. Certain embodiments may be implemented within a distributed computing environment, wherein tasks are executed by a remote processing device interconnected through a communications network. In such a distributed computing environment, software modules or components may reside in local and/or remote memory storage devices. Furthermore, data associatively linked or amalgamated within a database record may be present within the same memory device or distributed across several memory devices, interlinked within fields of a record in a database across a network.

Various embodiments may manifest as a computer program product, comprising a non-transitory machine-readable medium wherein instructions are stored. These instructions are employable to program a computer or other electronic device, facilitating the execution of processes as delineated herein. The non-transitory machine-readable medium encompasses, but is not limited to, hard drives, floppy diskettes, optical disks, CD-ROMs, DVD-ROMs, ROMs, RAMs, solid-state memory devices, or other forms of media/machine-readable medium adept at preserving electronic instructions. In certain embodiments, the computer or electronic device may integrate a processing unit such as a microprocessor, microcontroller, logic circuitry, or equivalent components.

What is claimed is:

1. A system for prediction and mitigation of grid congestion, the system comprising:
a processor configured to interface with a system-level digital replica of an electrical power grid (a “grid”), wherein creation of the system-level digital replica of the grid is based at least on a plurality of inputs comprising different representative models and data for emulation and prediction of a behavior of the grid; and
a non-transitory computer-readable storage medium configured to interface with the processor, the medium comprising instructions configured to prompt the processor to:
perform a predictive analysis of the grid based at least on a single timepoint or a plurality of timepoints for a basecase and one or more contingency cases related to (i) a plurality of grid planning scenarios, wherein the grid planning scenarios comprise planning periods of medium time periods or long time periods and (ii) a plurality of operations scenarios, wherein the operations scenarios comprise time periods of short-term planning, real-time operations, or look-ahead forecasts, wherein the predictive analysis is used to evaluate corresponding bus voltages and branch flows, wherein the branch flows comprise line flows or transformer flows, thereby identifying a plurality of congestion control candidates based at least on a congestion or an overload percentage in a plurality of branches;
perform a predictive control analysis for congestion mitigation in at least one branch for the single timepoint or the plurality of timepoints for the basecase and the one or more contingency cases related to the plurality of grid planning scenarios and the plurality of operations scenarios based at least on a coordination of assets in the grid, wherein the assets comprise sensor-free software-based evaluation of dynamic line ratings, power flow controllers based line impedance change, or grid topology control based circuit breaker status change;
perform a self-validation of a system impact of at least one congestion control candidate to determine a statistical probability of an undesirable side-effect;
display results of the predictive analysis, the predictive control analysis, or the self-validation for the single timepoint or the plurality of timepoints.

2. The system of claim 1, wherein the plurality of inputs for the creation of the digital replica comprises:
a first input comprising data determined from a power system network model;
a second input comprising data determined from a power system geospatial and vegetation model;
a third input comprising data determined from a power system asset characteristics model; and
a fourth input comprising data determined from a power system weather observation model.

3. The system of claim 1, wherein the system is further configured to generate and process dynamic data, wherein the dynamic data comprises:
a first input comprising a power system network state data;
a second input comprising a power system generation pattern or profile data;
a third input comprising a power system load pattern or profile data;
a fourth input comprising a power system outage schedule; and
a fifth input comprising a weather pattern.

4. The system of claim 1, wherein the system is further configured to:
predict the bus voltages and the branch flows across the grid for the single timepoint or the plurality of timepoints for the basecase or the plurality of contingency cases;
predict a list of branches through which the congestion or the overload percentage exceeds a user-defined threshold for the single timepoint or the plurality of timepoints; and
generate a shortlist of branches as congestion control candidates for congestion mitigation control for the basecase or the plurality of contingency cases.

5. The system of claim 4, wherein the system is further configured to:
provide capacity expansion control for at least one branch of the shortlist of branches by dynamically changing associated ratings using a sensor-free software dynamic line rating controller (S-DLRC).

6. The system of claim 5, wherein the system is further configured to:
identify optimal locations in the grid for an evaluation of dynamic line ratings.

7. The system of claim 5, wherein the system is further configured to:
autotune at least one of a plurality of weather attributes thereby mitigating an impact of bad data or missing data associated with historical data or forecasted data.

8. The system of claim 5, wherein the system is further configured to:
perform a computation of a set of normal ratings of a congested line or a selected line, wherein the computation comprises applying a heat balance equation across the congested line or the selected line, and wherein the heat balance equation uses data associated with weather attributes, geospatial attributes, or line flow.

9. The system of claim 8, wherein the system is further configured to:
perform a computation of maximum line conductor temperature based on the weather attributes, the geospatial attributes, or the line flow.

10. The system of claim 9, wherein the system is further configured to:
perform a computation of emergency ratings at different time periods based at least on the weather attributes, the geospatial attributes, the line flow, or the maximum line conductor temperature.

11. The system of claim 5, wherein the system is further configured to:
perform a computation of effective line ratings using a most limiting equipment rating in a line facility,
wherein the computation is used to automatically identify limiting components based at least on (i) an associated topological connectivity with a line or (ii) definitions provided by a user.

12. The system of claim 1, wherein the system is further configured to:
provide re-routing of power flow from congested branches to branches that are less congested by dynamically changing a line impedance of a line or a plurality of lines with power flow controllers, wherein the re-routing is performed by a wide-area based local and remote power flow controller (LR-PFC).

13. The system of claim 12, wherein the system is further configured to:
perform a computation of sensitivities of the congested branches, wherein the sensitivities are associated with lines (i) having power flow controllers or (ii) to be configured with new power flow controllers or additional power flow controllers.

14. The system of claim 13, wherein the system is further configured to:
create an optimal combination of the lines (i) having the power flow controllers or (ii) to be configured with the new power flow controllers or the additional power flow controllers;
provide settings related to an impedance change for obtaining a power flow change on the congested branches; and
perform a prediction of an impact of the power flow change on all branches in the grid caused by dynamically changing the line impedance using at least one power flow controller.

15. The system of claim 14, wherein the system is further configured to:
provide re-routing of the power flow from each congested branch to branches that are less congested by dynamically changing a circuit breaker status of one line and bus or a plurality of lines and buses, wherein the re-routing is performed using a grid topology controller (GTC).

16. The system of claim 15, wherein the system is further configured to:
perform a computation of sensitivities of the congested branches, wherein the computation comprises using all lines and buses in the grid.

17. The system of claim 16, wherein the system is further configured to:
determine an optimal combination of switching the lines and buses based at least on a flow change requirement on the congested branches;
automatically associate circuit breakers with the lines and buses for switching; and
perform a prediction of an impact of the power flow change on all branches in the grid caused by a status change of at least one circuit breaker.

18. The system of claim 1, wherein the system is further configured to:
provide an optimal coordination of all system controls, wherein the system controls comprise a software dynamic line rating controller (S-DLRC), a wide-area based local and remote power flow controller (LR-PFC), and a grid topology controller (GTC), and wherein the optimal coordination mitigates the congestion or the overload percentage in the branches for the one timepoint or the plurality of timepoints of the basecase and the plurality of contingency cases.

19. The system of claim 18, wherein the system is further configured to:
perform a grid feasibility test with a short list of the system controls to determine a stability of a post-control grid state;
perform a grid reliability test with the short list of the system controls to determine a loss of critical assets, wherein the critical assets comprise generators or loads, and wherein the loss is caused by an impact of at least one system control in the post-control grid state;
perform a grid congestion test with the short list of the system controls to determine the congestion or the overload percentage in all branches in the post-control grid state,
wherein, if any test fails, the optimal combination of system controls is changed automatically to alternative controls until (i) the congestion or the overload percentage of all branches in the grid is below a user-defined threshold or (ii) all possible combinations of system controls are considered.

20. The system of claim 1, wherein the system is further configured to:
display results of the basecase and the contingency cases for the single timepoint or the plurality of timepoints determined from the predictive analysis; and
display results of the basecase and the contingency cases for the single timepoint or the plurality of timepoints determined from the predictive control analysis.
